(19) United States
(12) Patent Application Publication
(10) Pub. No.: US 2009/0207230 A1
(43) Pub. Date: Aug. 20, 2009

(54) IMAGE FORMING APPARATUS AND IMAGE FORMING APPARATUS CONTROL PROGRAM

(76) Inventor: Kouichi TAKAKI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/369,503

(22) Filed: Feb. 11, 2009

(30) Foreign Application Priority Data
Feb. 15, 2008 (JP) JP2008-034381

(51) Int. Cl. B41J 2/435

(52) U.S. Cl. 347/235

(57) ABSTRACT

An image forming apparatus which concurrently exposes by multiple laser beams corresponding to M lines on the photoreceptor, comprising: multiple light sources for emitting laser beams; a memory section for storing the image data; a control section to control the plurality of light sources, wherein the control section is capable of controlling image formation by: a first mode for reading-out of image data for M lines, exposing by multiple light sources of M lines according to the image data for M lines, and forming an image at a predetermined sub-scanning direction image formation speed of VM; and a second mode for reading-out of image data for N lines (where N<M), exposing by multiple light sources of M lines according to read-out image data for N lines and blank data for M−N lines, and forming an image at a sub-scanning direction image formation speed VN, where VN=VM−(N/M).

### CROSS REFERENCE TO RELATED APPLICATION

The present application is based on Japanese Patent Application No. 2008-034381 filed with Japanese Patent Office on Feb. 15, 2008, the entire content of which is hereby incorporated by reference.

### BACKGROUND OF THE INVENTION

1. Technical Field

The present invention relates to an image forming apparatus and an image forming apparatus control program, such as a copying machine and a printer. The present invention particularly relates to a multi-beam type image forming apparatus, which has a function for writing-in an image of a plurality of lines onto a recording media, such as a photo conductor by one scan using laser beams from a plurality of light sources and its control program.

2. Description of Prior Art

As an image forming apparatus, an image forming apparatus, which performs image formation of one line of a main scanning direction corresponding to image data and performs image formation of one page by repeating image formation in every line of a main scanning direction to a sub-scanning direction, is known.

As the example, in an image forming apparatus of an electrophotographic method, a laser beam modulated according to the image data is scanned in a scanning direction of a photoconductor, and concurrently, an image is formed by the laser beam on an image carrier (photoconductor drum), which rotates in a sub-scanning direction. In this case, the laser beam is modulated by image data on the basis of a clock signal (pixel clock) called a dot clock.

In order to perform image formation at high speed or with high resolution, an image forming apparatus that includes light sources, such as a plurality that is greater that two or three of laser diodes (LD), and performs image formation by repeating the image formation for a plurality of lines of the main scanning direction corresponding to the image data in a sub-scanning direction using the laser beam from this plurality of light sources. Such multi-beam type image forming apparatus is described, for example, in Japanese Patent Application Publication No. 2002-166593

Various multi-beam type image forming apparatuses are described, for example, in Japanese Patent Application Publications No. 2002-166593 and No. 2003-150002. Meanwhile, it is also possible to form an image onto transfer paper sheets other than the usual regular paper sheet. However, in the case of thick paper, it is necessary to pass the paper through a fixing section at a low speed. In this case, it is necessary to reduce a conveyance speed of the transfer paper sheet in an entire image forming apparatus.

As for such low-speed image formation, there exist techniques, such as rotation speed change of a polygon mirror, change of a polygon index cycle, and frequency change of an operation clock. In this case, a load of a polygon motor is heavy and it becomes undesirable state to stably use the image forming apparatus for a long period of time in the technique of altering polygon mirror rotation speed and a polygon index cycle. Further, a problem of requiring a certain time for the rotation of polygon mirror to be stable after changing the rotation speed of the polygon mirror is caused.

Then, a method of switching the switching sub-scanning direction image formation speed to low speed by reducing a light source to be used, namely, the number of beam to be used in multi-beam image formation without changing the rotation speed of a polygon mirror is described in Japanese. Patent Application Publications No. 2002-166593 and No. 2003-150002.

In the above patent references, although the technology with respect to a beam switching is described, a control program becomes complicated and the problem that program capacity (memory capacity) increases is newly generated.

In the case of reducing the light source to be used in the above-mentioned way, the light source to be used can be reduced only with a fixed rate (by every ½), such as ½, ¼, and ⅛. Therefore, there is a problem that an arbitrary sub-scanning direction image formation speed, such as ¾ that is other than the fixed rates, cannot be applicable.

In the techniques of changing rotation of a polygon mirror or a polygon index cycle, and of changing the number of light sources as mentioned above, control changes corresponding to each changed sub-scanning direction image formation speed. Therefore, the changes of the control circuit and a control program according to each sub-scanning direction image formation speed, or the signal was needed.

The present invention has been made to solve the above-mentioned problem. An object of the present invention is to realize an image forming apparatus and the image forming apparatus control program, which can change a sub-scanning direction image formation speed with a stabilized state without requiring change of the rotation number of the polygon mirror, a polygon index, a number of light source used or an operation clock.

### SUMMARY

An image forming apparatus reflecting one aspect of the present invention, which solves the above-mentioned problem, is image forming apparatus which scans a photoreceptor by a plurality of laser beams from a plurality of light sources in a main scanning direction, and concurrently executes exposures corresponding to a plurality of M lines on the photoreceptor, the image forming apparatus including:

a plurality of light sources for emitting laser beams according to image data;

a memory section for storing the image data to be used for emitting the laser beams;

a control section which controls to drive the plurality of light sources for emitting the laser beams according to the image data read from the memory section,

wherein the control section is capable of controlling image formation by:

a first image formation mode for executing reading-out of image data for M lines by every one scanning period from the memory section, executing the exposures by driving the plurality of light sources of M lines provided in parallel to each other according to the image data for M lines, and performing the image formation at a predetermined sub-scanning direction image formation speed of VM; and

a second image formation mode for executing reading-out of image data for N lines (where N<M) by every single scanning period from the memory section, executing the exposures by driving the plurality of light sources of M lines provided in parallel to each other according to read-out image data for N lines and blank data for M−N lines, and performing the image formation at a sub-scanning direction image formation speed VN, where VN=VM−(N/M).

A computer-readable storage medium reflecting another aspect of the present invention is the storage medium stored therein a program which allows a computer to control an image forming apparatus which scans a photoreceptor by a plurality of laser beams from a plurality of light sources in a main scanning direction, and concurrently executes exposures corresponding to a plurality of M lines on the photoreceptor, the image forming apparatus comprising: a plurality of light sources for emitting laser beams according to image data; a memory section for storing the image data to be used for emitting the laser beams; a control section which controls to drive the plurality of light sources for emitting the laser beams according to the image data read from the memory section,

wherein the program enables the image forming apparatus to execute either one of a first image formation mode and a second formation mode, wherein in the first image formation mode the control section controls to execute the steps of:

reading-out of image data for M lines by every one scanning period from the memory section;

exposing the photoreceptor by driving the plurality of light sources of M lines provided in parallel to each other according to the image data for M lines; and

forming an image at a predetermined sub-scanning direction image formation speed of VM, and in the second image formation mode the control section controls to execute the steps of:

reading-out of image data for N lines (where N<M) by every single scanning period from the memory section;

exposing the photoreceptor by driving the plurality of light sources of M lines provided in parallel to each other according to read-out image data for N lines and blank data for M−N lines; and

forming an image at a sub-scanning direction image formation speed VN, where VN=VM−(N/M).

### BRIEF DESCRIPTION OF THE DRAWING

These and other objects, advantages and features of the invention will become apparent from the following description thereof taken in conjunction with the accompanying drawings in which:

FIG. 1 illustrates a block diagram showing a configuration of an image forming apparatus of an embodiment of the present invention;

FIG. 2 illustrates an explanatory view showing a configuration of an image forming apparatus of the embodiment of the present invention;

FIGS. 3(a1)-3(e2) illustrate a time chart describing an operating state of the image forming apparatus of an embodiment of the present invention;

FIG. 4 illustrates a flow chart describing the operating state of the image forming apparatus of an embodiment of the present invention;

FIGS. 5(a1)-5(e2) illustrate a time chart describing the operating state of the image forming apparatus of an embodiment of the present invention;

FIG. 6 illustrates a block diagram showing the configuration of the image forming apparatus of an embodiment of the present invention; and

FIGS. 7(a1)-7(f2) illustrate a time chart describing the operating state of the image forming apparatus of an embodiment of the present invention.

### DETAILED DESCRIPTION OF THE PREFERRED EMBODIMENTS

Hereafter, a preferred configuration (embodiment) for carrying out the present invention is described in detail in reference to drawings. An image forming apparatus to which this embodiment is applied is an image forming apparatus of a multi-beam type, which concurrently scans a plurality of laser beams from a plurality of light sources in a main scanning direction of an image carrier and performs exposure for a plurality of lines.

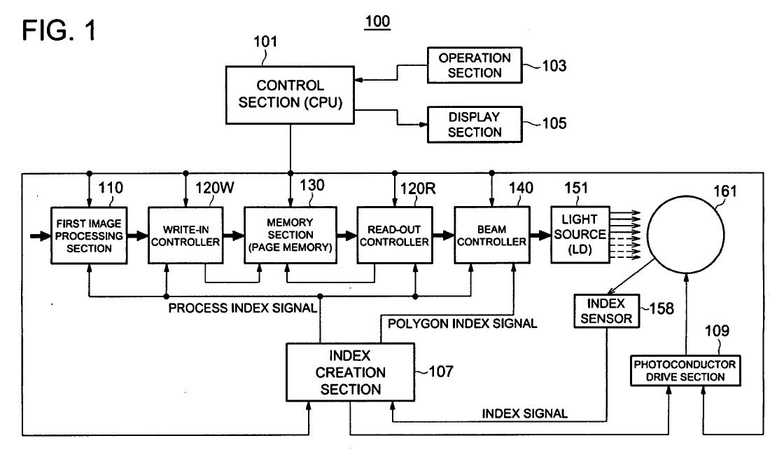

Hereafter, an electrical configuration of a first embodiment of an image forming apparatus 100 of the multi-beam type of this embodiment of the present invention will be described in detail based on FIG. 1. In this embodiment, a fundamental configuration requirement of the image forming apparatus 100 using a plurality of laser beams for exposure without degrading image quality is described in focus. Therefore, it is general as the image forming apparatus, and description about well-known configuration requirement is omitted.

### A First Embodiment

101 is a control section configured by a CPU to control each section of the image forming apparatus 100 etc. 103 is an operation section into which an operator inputs various instructions. 105 is a display section onto which various states and message of the image forming apparatus 100 are displayed.

107 is an index creation section for creating a process INDEX signal and a polygon INDEX signal based on the horizontal synchronizing signal (INDEX signal) as a detection result of the laser beam scanned by a polygon mirror. 109 is a photoconductor drive section for rotating a photoconductor drum 161 at a predetermined sub-scanning direction image forming speed.

110 is an image processing section for performing a predetermined image processing corresponding to image data. 120W is a write-in controller for controlling write-in to a memory section 130. 120R is a read-out controller for controlling read-out to the memory section 130. 130 is the memory section configured by a page memory that memorizes image data. 140 is a beam controller performing a drive and control of light emission of laser corresponding to a predetermined command and the image data that were read-out. 151 is a light source for generating a plurality of laser beams for exposure based on the drive and control of the beam controller 140.

158 is an index sensor for detecting the scanned laser beam, and for generating and supplying the horizontal synchronizing signal (INDEX signal) to the index creation section 107. 161 is a photoconductor drum in which an image is formed by the laser beam scan.

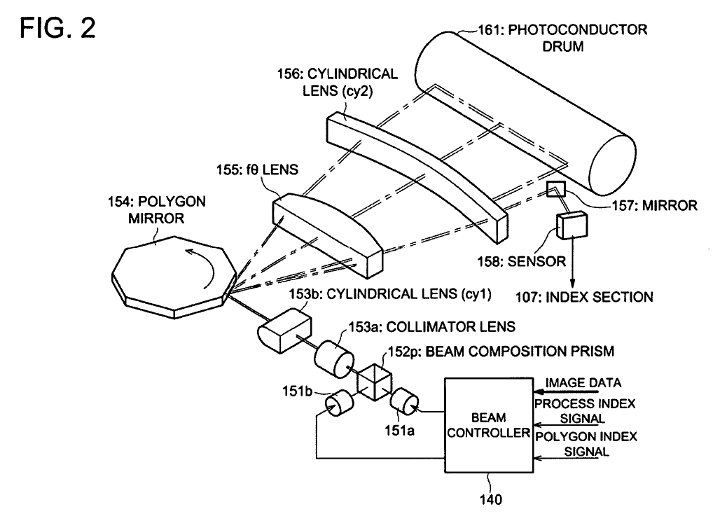

FIG. 2 is an explanatory view schematically showing a part of a perspective view of vicinity of the beam controller 140, an exposure unit 150, and the photoconductor drum 161. Here, as a specific example, a case of two laser beams as a plurality of laser beams is illustrated.

In this FIG. 2, the exposure unit 150 is configured by a semiconductor laser 151 (151a and 151b) as a plurality of light sources that generates a plurality of laser beams, a beam composition prism 152p for synthesizing the laser beams, a collimator lens 153a and a cylindrical lens 153b for optically performing various adjustments to a laser beam, a polygon mirror 154 for scanning the laser beam in a main scanning direction, a fθ lens 155 for optically adjusting a scanning angle, a cylindrical lens 156 for performing optical adjustment, a mirror 157 for horizontal synchronizing signal detection, and a horizontal synchronization sensor 158 for horizontal synchronizing signal detection.

The section shown as the semiconductor lasers 151a and 151b in this FIG. 2 may be configured with an optical section that synthesizes a plurality of laser beams configured by a plurality of semiconductor lasers, and may be a plurality of beam laser arrays formed into one. In an example mentioned later, eight light sources (LD 1-LD 8) are provided as the semiconductor laser 151.

A plurality of laser beams scanned as mentioned above is scanned on the photoconductor drum 161 as an image carrier. Then, a latent image corresponding to a laser beam is formed on the plane of the photoconductor drum 161 by considering rotation of the photoconductor drum 161 as a scan in the sub-scanning direction. In a case of a color image forming apparatus, the exposure unit 150 shown here is arranged for a number of colors.

In the above-mentioned configuration, the image processing section 110 is an image processing section for performing various kinds of image processing required for image formation. In this embodiment, the image processing section 110 has a function to concurrently outputting image data for each line corresponding to a plurality of light sources to perform simultaneous exposure by the plurality of light sources.

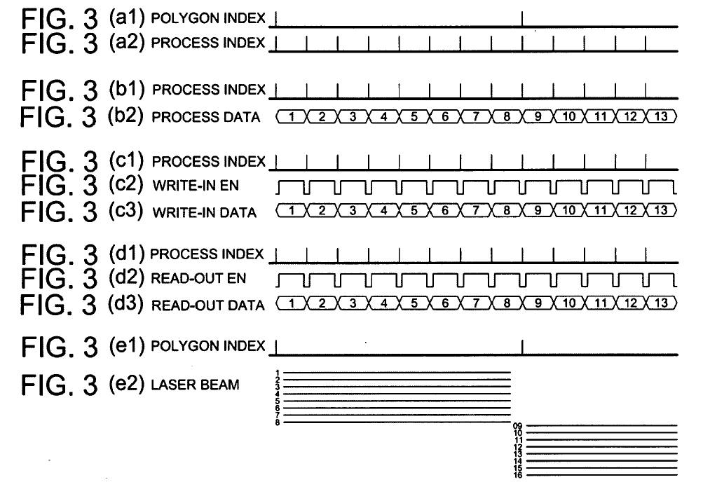

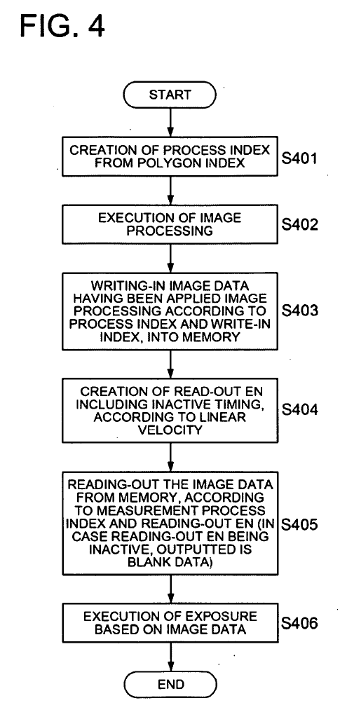

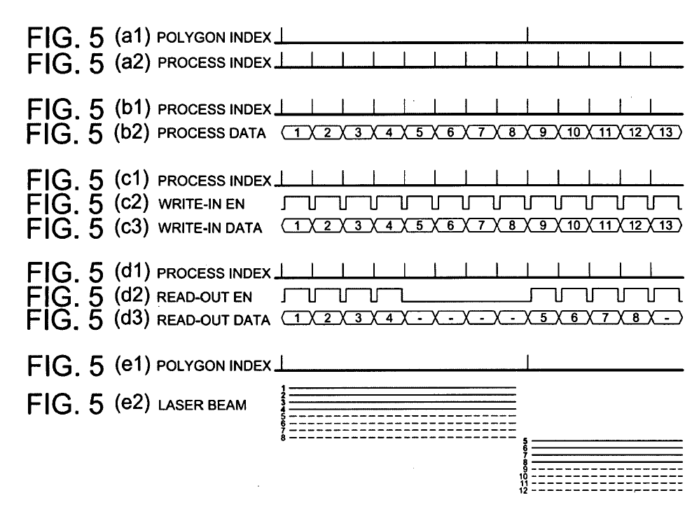

Hereafter, a first operation (a first embodiment) of the image forming apparatus 100 of this embodiment will be described in reference to a time chart of FIGS. 3(a1)-3(e2), a flow chart of FIG. 4, and a time chart of FIGS. 5(a1)-(e2). In this embodiment, as shown in FIG. 2, a case where a eight-sided polygon mirror 154 is used is shown as an example.

A first image formation mode is described in reference to FIGS. 3(a1)-3(e2). The index creation section 107 creates a polygon INDEX signal that becomes a timing signal for every exposure of one main scan on the basis of the INDEX signal acquired by the index sensor 158 (FIG. 3(a1) and S401 of FIG. 4).

Along with this, the index creation section 107 creates a process index signal for performing a process corresponding to a number of the maximum simultaneous exposure of the light source 151 for every one main scan (FIG. 3(a2)). This process index signal is a signal that is acquired by dividing the polygon INDEX signal evenly with a number of the maximum simultaneous exposure.

A process of image data for every one main scan line is performed (FIG. 3(b2) and S402 of FIG. 4) in the image processing section 110 based on this process index signal (FIG. 3(b1). A write-in EN (enable) signal (FIG. 3(c2)) for writing-in image data processed for every one main scan line to the memory section 130 is created based on the process index signal (FIG. 3(c1)) in the write-in controller 120W. In this write-in EN signal (FIG. 3(c2)), H level is active and the write-in is performed to the memory section 130 (FIG. 3(c3) and S403 of FIG. 4).

A read-out EN (enable) signal (FIG. 3(d2)) for reading-out the image data memorized for every one main scan line from the memory section 130 is created based on the process index signal (FIG. 3(d1)) in the read-out controller 120R (S404 in FIG. 4 (however, since it is in a first image formation mode, there is no un-active timing)). In this read-out EN signal (FIG. 3(d2)), H level is active and read-out is performed from the memory section 130 (FIG. 3(d3)).

In the beam controller 140, a drive signal for simultaneously exposing the image data for eight main scanning being the number of the maximum simultaneous exposure of the light source is created to have the light source 151 emit light (FIG. 3(e2) and S406 of FIG. 4) based on the polygon INDEX signal (FIG. 3(e1)).

Namely, in this first image formation mode, an exposure corresponding to the number of the maximum simultaneous exposure of light source 151 is performed, and the photoconductor drive section 109 rotates the photoconductor drum 161 at the sub-scanning direction image formation speed corresponding to this exposure.

Therefore, on a plane of a polygon mirror, image formation for eight lines of 1-8 main scanning line is performed, and on a next plane of the polygon mirror, the image formation of eight lines of 9-16 main scan is performed. The photoconductor drive section 109 rotates the photoconductor drum 161 for eight lines of main scanning by every one plane (every polygon INDEX signal cycle) of the polygon mirror 154 (FIG. 3(e1)(e2)).

Next, a second image formation mode is described in reference to FIGS. 5(a1)-5(e2). Here, a case where the sub-scanning direction image formation speed is half of the first image formation mode is illustrated as an example of the second image formation mode.

The index creation section 107 creates the polygon INDEX signal that becomes a timing signal for every exposure of one main scan on the basis of the INDEX signal acquired by the index sensor 158 (FIG. 5(a1) and S401 of FIG. 4).

Along with this, the index creation section 107 creates the process index signal that performs processing corresponding to the number of the maximum simultaneous exposure of the light source 151 for every one main scanning (FIG. 5(a2)). This process index signal is a signal that is acquired by dividing the polygon INDEX signal evenly with a number of the maximum simultaneous exposure.

A process of the image data for every one main scanning line is performed (FIG. 5(b2) and S402 of FIG. 4) in the image processing section 110 based on this process index signal (FIG. 5(b1)). A write-in EN (enable) signal (FIG. 5(c2)) for writing-in an image data processed for every one main scanning line to a memory section 130 is created based on the process index signal (FIG. 5(c1)) in the write-in controller 120W. In this write-in EN signal (FIG. 5(c2)), H level is active and the write-in is performed to the memory section 130 (FIG. 5(c3) and S403 of FIG. 4).

A read-out EN (enable) signal (FIG. 5(d2)) for reading-out the image data memorized for every one main scanning line from the memory section 130 is created based on the process index signal (FIG. 5(d1)) in the read-out controller 120R (S404 in FIG. 4). In this read-out EN signal (FIG. 3(d2)), H level is active and read-out is performed from the memory section 130 (FIG. 3(d3)).

In this second image formation mode, the sub-scanning direction image formation speed is half of the first image formation mode. Therefore, in case when the image formation of the main scanning direction of eight lines is performed for one plane of the polygon mirror 154 in the first image formation mode, it is set so as to be four active: four inactive to perform the image formation of the main scanning direction of four lines for one plane of the polygon mirror 154 in the second image formation mode. Namely, as the read-out EN signal, it is set so as to be four active: four inactive for eight index signal.

As a result, with respect to the image,data read-out of the memory section 130, in one index signal cycle, the image data 1-4 are ordinarily read-out, and blank data is outputted at the timing equivalent to the image data 5-8. Here, the blank data is referred to a signal that will not output ink or a toner.

In the beam controller 140, a drive signal for simultaneously exposing the image data for eight main scanning being the number of the maximum simultaneous exposure of the light source is created to have the light source 151 emit light (FIG. 5(e2) and S406 of FIG. 4) based on the polygon INDEX signal (FIG. 5(e1)).

Namely, in this second image formation mode, the exposure corresponding to the number of the maximum simultaneous exposure of light source 151 is performed as a circuit operation. However, in fact, the exposure is actually performed on four lines out of eight lines of the main scanning direction (solid line of FIG. 5(e2)) since it is in a state where the blank data is included. Therefore, the photoconductor drive section 109 rotates the photoconductor drum 161 at the sub-scanning direction image formation speed corresponding to this exposure of four lines.

Therefore, on a plane of the polygon mirror, image formation for four lines of 1-4 out of 1-8 main scanning of the eight lines is substantially performed, and on a next plane of the polygon mirror, image formation for four lines of 5-8 main scanning is substantially performed.

Therefore, the photoconductor drive section 109 rotates the photoconductor drum 161 at the sub-scanning direction image formation speed that is normally half of the four lines of main scanning for every one plane of the polygon mirror 154 (every polygon INDEX signal cycle).

As mentioned above, in this embodiment, the following two kinds of image formation modes are included in case when concurrently scanning a plurality of laser beams from a plurality of light sources in the main scanning direction of the image carrier, and performing the exposure of a plurality of M (M=8) lines.

In the first image formation mode, image formation is performed at the predetermined sub-scanning direction image formation speed VM by reading out the image data for M (M=8) line from the above-mentioned memory section for every one scanning period and performing exposure by the drive of the light source having M lines which are parallel to each other corresponding to the image data for read M line scanning.

In the second image formation mode, the image formation is performed at the sub-scanning direction image formation speed VN (VN=VM×(N/M)) by reading out the image data for N (N<M, N=4) lines from the above-mentioned memory section and performing exposure by the drive of the light source having M lines which are parallel to each other corresponding to the read-out image data for N lines and the blank data for M−N lines.

Here, the control of the timing of the write-in and read-out to a memory is not changed in the above-mentioned first image formation mode and the above-mentioned second image formation mode. Although timing does not change, the number of data that performs read-out is changed corresponding to the sub-scanning direction image formation speed, and the blank data is added into the portion that is not read-out.

Here, in the above-mentioned second image formation mode, the rotation speed of a polygon mirror is not changed from the above-mentioned first image formation mode. Here, a control of the light source used for exposure is not changed in the above-mentioned first image formation mode and the above-mentioned second image formation mode.

As a result, according to this embodiment, the sub-scanning direction image formation speed can be changed in a stable state without requiring the change of a number of polygon mirror rotations, a polygon index, the number of light sources used, or an operation clock.

In this embodiment, a complicated control program, such as the technology related to a beam change, is not necessary, and program capacity (memory capacity) does not increase. Since the technology of reducing the light source to be used is not exercised in this embodiment, realizing the sub-scanning direction image formation speed other than a fixed rates, such as ½, ¼, and ⅛ (varied by ½), is possible, and realizing an arbitrary sub-scanning direction image formation speeds, such as 6/8, ⅝, ⅜, and ¾, are possible.

In this embodiment, the technique of changing rotation of the polygon mirror and the polygon index cycle is not used. Therefore, the control circuit and control program corresponding to each changed sub-scanning direction image formation speed, or the change of a signal become unnecessary. Thus, a control, a program and a signal can be simplified.

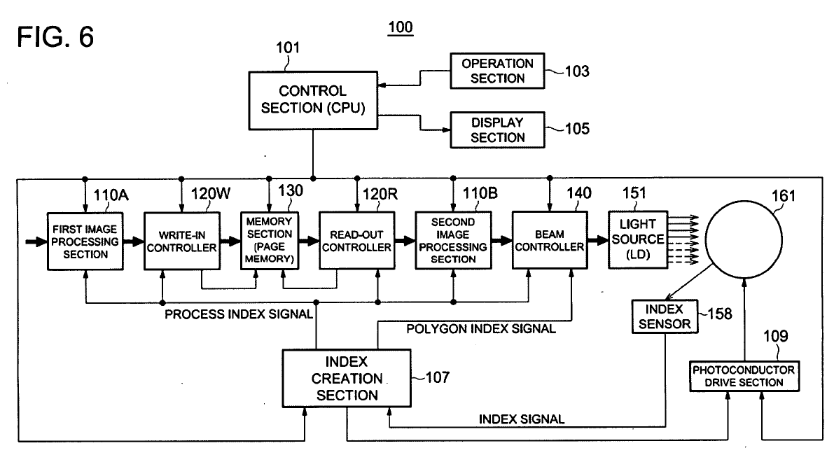

It is also possible to configure the image forming apparatus 100 of the embodiment as shown in FIG. 6. Here, the image forming apparatus 100 includes a first image processing section 110A for performing image processing before the memory section 130, and a second image processing section 110B for performing image processing after the memory section 130.

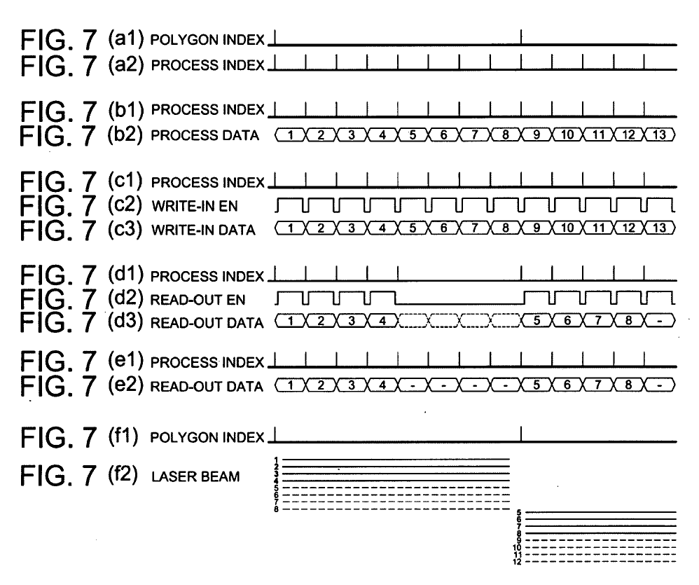

Next, the second image formation mode is described in reference to FIGS. 7(a1)-7(f2). Here, a case where the sub-scanning direction image formation speed is half of the first image formation mode is illustrated as an example of the second image formation mode.

The index creation section 107 creates the polygon INDEX signal that becomes a timing signal for every exposure of one main scanning on the basis of the INDEX signal acquired by the index sensor 158 (FIG. 7(a1) and S401 of FIG. 4).

Along with this, the index creation section 107 creates the process index signal that performs processing corresponding to the number of the maximum simultaneous exposure of the light source 151 for every one main scanning (FIG. 7(a2)). This process index signal is a signal that is acquired by dividing the polygon INDEX signal evenly with a number of the maximum simultaneous exposure.

A process of the image data for every one main scanning line is performed (FIG. 7(b2) and S402 of FIG. 4) in the image processing section 110A based on this process index signal (FIG. 7(b1)). A write-in EN (enable) signal (FIG. 7(c2)) for writing-in an image data processed for every one main scanning line to a memory section 130 is created based on the process index signal (FIG. 7(c1)) in the write-in controller 120W. In this write-in EN signal (FIG. 7(c2)), H level is active and the write-in is performed to the memory section 130 (FIG. 7(c3) and S403 of FIG. 4). Namely, a write-in of the image data is sequentially executed at a normal timing.

In this second image formation mode, the sub-scanning direction image formation speed is half of the first image formation mode. Therefore, in case when the image formation of the main scanning direction of eight lines was performed for one plane of the polygon mirror 154 in the first image formation mode, it is set so as be four active: four inactive to perform the image formation of the main scanning direction of four lines for one plane of the polygon mirror 154 in the second image formation mode. Namely, the index creation section 107 creates a dedicated index signal in which the primary eight INDEX signals are divided to four active: four inactive. Then, the index creation section 107 supplies the dedicated signal to the read-out controller 120R (FIG. 7(d1)).

A read-out EN (enable) signal (FIG. 7(d2)) for reading-out the image data memorized for every one main scanning line from the memory section 130 is created based on the process index signal (FIG. 7(d1)) in the read-out controller 120R (S404 in FIG. 4). Namely, as the read-out EN signal, it is set so as to be four active: four inactive for eight index signal in here. As a result, in this read-out EN signal (FIG. 7(d2)), H level is active and the read-out is performed from the memory section 130 (numbers 1-4 portion of FIG. 7(d3)), and L level is inactive and read-out is not performed from the memory section 130 (a dashed line portion of FIG. 7(d3)).

Thereby, with respect to the image data read-out of the memory section 130, in one index signal cycle, the image data 1-4 are ordinarily read-out, and the read-out is not performed at the timing that is equivalent to read-out of the image data 5-8.

A process of the image data for every one main scanning line is performed based on a process index signal (FIG. 7(e1)) in the second image processing section 110B (FIG. 7(e2)). Here, the actual image data is image processed as four lines of 1-4. On the other hand, the read-out for 5-8 lines is not performed and, in fact, data does not exist. However, 5-8 lines are processed and created as the blank data based on the process index signal (FIG. 7(e1)). Here, the blank data is referred to a signal that will not output ink or a toner.

In the beam controller 140, a drive signal for simultaneously exposing the image data for eight main scanning being the number of the maximum simultaneous exposure of the light source is created to have the light source 151 emit light based on the polygon INDEX signal (FIG. 7(f1)) (FIG. 7(f2) and S406 of FIG. 4).

Namely, in this second image formation mode, the exposure corresponding to the number of the maximum simultaneous exposure of light source 151 is performed as a circuit operation. However, in fact, the exposure is actually performed on four lines out of eight lines of the main scanning direction (solid line of FIG. 7(f2)) since it is in a state where the blank data is included. Therefore, the photoconductor drive section 109 rotates the photoconductor drum 161 at the sub-scanning direction image formation speed corresponding to this exposure for four lines.

Therefore, on a plane of the polygon mirror, image formation for four lines of 1-4 out of 1-8 main scanning of the eight lines is performed substantially, and on a next plane of the polygon mirror, image formation for four lines of 5-8 main scanning is substantially performed (a solid line of FIG. 7(f2)).

Therefore, the photoconductor drive section 109 rotates the photoconductor drum 161 at the sub-scanning direction image formation speed corresponding to four lines of main scanning for every one plane of the polygon mirror 154 (every polygon INDEX signal cycle), the speed being half of the regular speed.

As mentioned above, in this embodiment, the following two kinds of image formation modes are included in case when concurrently scanning a plurality of laser beams from a plurality of light sources in the main scanning direction of an image carrier, and performing the exposure of a plurality of M (M=8) lines.

In the first image formation mode, image formation is performed at the predetermined sub-scanning direction image formation speed VM by reading out the image data for M (M=8) line from the above-mentioned memory section for every one scanning period and performing exposure by the drive of the light source having M lines which are parallel to each other corresponding to the image data for read M line.

In the second image formation mode, the image formation is performed at the sub-scanning direction image formation speed VN (VN=VM×(N/M)) by reading out the image data for N (N<M, N=4) lines from the above-mentioned memory section and performing exposure by the drive of the light source having M lines which are parallel to each other corresponding to the read-out image data for N lines and the blank data for M−N lines.

Here, the control of the timing of the write-in and read-out to the memory is not changed in the above-mentioned first image formation mode and the above-mentioned second image formation mode. Although the timing does not change, the number of data that performs read-out is changed corresponding to the sub-scanning direction image formation speed, and blank data is added in the portion that is not read.

Here, in the above-mentioned second image formation mode, the rotation speed of a polygon mirror is not changed from the above-mentioned first image formation mode. Here, the control of the light source used for exposure is not changed in the above-mentioned first image formation mode and the above-mentioned second image formation mode.

As a result, according to this embodiment, the sub-scanning direction image formation speed can be changed in a stable state without requiring the change of a rotation speed of polygon mirror, a polygon index, the number of light sources used, and an operation clock.

In this embodiment, a complicated control program such as the technology about a beam change is not necessary, and program capacity (memory capacity) does not increase. Since the technology for reducing the light source to be used is not applied in this embodiment, realizing the sub-scanning direction image formation speed other than the fixed rate (by ½), such as ½, ¼, and ⅓, is possible, and realizing an arbitrary sub-scanning direction image formation speeds, such as 6/8, ⅝, ⅜, and ¾, are possible.

In this embodiment, since the technique of changing rotation of the polygon mirror or the polygon index cycle is not used, the control circuit and control program corresponding to each changed sub-scanning direction image formation speed, or the change of a signal become unnecessary. Therefore, a control, a program and a signal can be simplified.

### Other Embodiment (1)

The image forming apparatus of the electrophotographic method using the laser beam is described in the above-mentioned embodiment. However, it is not limited to this. For example, it is possible to apply each embodiment of the present invention to various kinds of image forming apparatuses, such as a laser imager that performs exposure on a photographic paper using a laser beam, and it is possible to obtain a satisfactory result.

### Other Embodiment (2)

Even when other light sources other than the semiconductor laser (LD) are used as a light source, it is applicable to the present invention.

### Other Embodiment (3)

In the above-mentioned embodiment, for convenience, it was called the first image formation mode/the second image formation mode. However, it is possible to perform the similar processing as the above-mentioned embodiment irrespective of these names.

Namely, even if it is configured so that the sub-scanning direction image formation speed varies only in the image formation mode that is equivalent to the above-mentioned second image formation mode without having the above-mentioned first image formation mode, it is a part (or modification) of an embodiment of the present invention.

What is claimed is:

1. An image forming apparatus which scans a photoreceptor by a plurality of laser beams from a plurality of light sources in a main scanning direction, and concurrently executes exposures corresponding to a plurality of M lines on the photoreceptor, the image forming apparatus comprising:
a plurality of light sources for emitting laser beams according to image data;
a memory section for storing the image data to be used for emitting the laser beams;
a control section which controls to drive the plurality of light sources for emitting the laser beams according to the image data read from the memory section,
wherein the control section is capable of controlling image formation by:
a first image formation mode for executing reading-out of image data for M lines by every one scanning period from the memory section, executing the exposures by driving the plurality of light sources of M lines provided in parallel to each other according to the image data for M lines, and performing the image formation at a predetermined sub-scanning direction image formation speed of VM; and
a second image formation mode for executing reading-out of image data for N lines (where N<M) by every single scanning period from the memory section, executing the exposures by driving the plurality of light sources of M lines provided in parallel to each other according to read-out image data for N lines and blank data for M−N lines, and performing the image formation at a sub-scanning direction image formation speed VN, where VN=VM−(N/M).

2. The image forming apparatus of claim 1, wherein the control section does not change timing controls of writing-in and reading-out the image data to and from the memory section between the first image formation mode and the second image formation mode.

3. The image forming apparatus of claim 1, further comprising a polygon mirror for scanning the laser beams, wherein the control section does not change a rotation speed of a polygon mirror between the first image formation mode and the second image formation mode.

4. The image forming apparatus of claim 1, wherein the control section does not change timing controls of driving the plurality of light sources between the first image formation mode and the second image formation mode.

5. A computer-readable storage medium stored therein a program which allows a computer to control an image forming apparatus which scans a photoreceptor by a plurality of laser beams from a plurality of light sources in a main scanning direction, and concurrently executes exposures corresponding to a plurality of M lines on the photoreceptor, the image forming apparatus comprising: a plurality of light sources for emitting laser beams according to image data; a memory section for storing the image data to be used for emitting the laser beams; a control section which controls to drive the plurality of light sources for emitting the laser beams according to the image data read from the memory section,
wherein the program enables the image forming apparatus to execute either one of a first image formation mode and a second formation mode, wherein in the first image formation mode the control section controls to execute the steps of:
reading-out of image data for M lines by every one scanning period from the memory section;
exposing the photoreceptor by driving the plurality of light sources of M lines provided in parallel to each other according to the image data for M lines; and
forming an image at a predetermined sub-scanning direction image formation speed of VM, and in the second image formation mode the control section controls to execute the steps of:
reading-out of image data for N lines (where N<M) by every single scanning period from the memory section;
exposing the photoreceptor by driving the plurality of light sources of M lines provided in parallel to each other according to read-out image data for N lines and blank data for M−N lines; and
forming an image at a sub-scanning direction image formation speed VN, where VN=VM−(N/M).

6. The computer-readable storage medium of claim 5, wherein the control section does not to change timing controls of writing-in and reading-out the image data to and from the memory section between the first image formation mode and the second image formation mode.

7. The computer-readable storage medium of claim 5, wherein the image forming apparatus further comprises a polygon mirror for scanning the laser beams, and wherein the control section does not control to change a rotation speed of a polygon mirror between the first image formation mode and the second image formation mode.

8. The computer-readable storage medium of claim 5, wherein the control section does not control to change timing controls of driving the plurality of light sources between the first image formation mode and the second image formation mode.

9. An image forming method utilizing an image forming apparatus which comprises a plurality of light sources for emitting laser beams according to image data; a memory section for storing the image data to be used for emitting the laser beams; a control section which controls to drive the plurality of light sources for emitting the laser beams according to the image data read from the memory section, the image forming method comprising:
scanning a photoreceptor by a plurality of laser beams from the plurality of light sources in a main scanning direction, and concurrently executing exposures corresponding to a plurality of M lines on the photoreceptor;
wherein in a first image formation mode:
reading-out of image data for M lines by every one scanning period from the memory section;
exposing the photoreceptor by driving the plurality of light sources of M lines provided in parallel to each other according to the image data for M lines; and
forming an image at a predetermined sub-scanning direction image formation speed of VM, and
in a second image formation mode:
reading-out of image data for N lines (where N<M) by every single scanning period from the memory section;
exposing the photoreceptor by driving the plurality of light sources of M lines provided in parallel to each other according to read-out image data for N lines and blank data for M−N lines; and
forming an image at a sub-scanning direction image formation speed VN, where VN=VM−(N/M).
